(19) United States
(12) Patent Application Publication
(10) Pub. No.: US 2010/0059145 A1
(43) Pub. Date: Mar. 11, 2010

(54) METAL FOIL

(75) Inventors: Heike Hattendorf, Werdohl (DE); Bodo Gehrmann, Plettenberg (DE); Michael Baecker, Koeln (DE); Joerg Eickemeyer, Dresden (DE)

Correspondence Address: JORDAN AND HAMBURG LLP, 122 EAST 42ND STREET, SUITE 4000, NEW YORK, NY, 10168, US

(73) Assignees: THYSSENKRUPP VDM GMBH, Werdohl (DE); ZENERGY POWER GMBH, Rheinbach (DE)

(21) Appl. No.: 12/596,526

(22) PCT Filed: Apr. 14, 2008
(86) PCT No.: PCT/DE08/00615

§ 371 Date: Oct. 19, 2009

(30) Foreign Application Priority Data
Apr. 17, 2007 (DE) 10 2007 018 408.7
Mar. 27, 2008 (DE) 10 2008 016 222.1

(51) Int. Cl. C22C 19/03; B32B 15/00

(52) U.S. Cl. 148/429; 428/606

(57) ABSTRACT

The invention relates to a metal foil having (in weight %) Ni 74-90%, W 10-26%, and Al and/or Mg and/or B contents of Al >0-max. 0.02%, Mg >0-max. 0.025%, B>0-max. 0.005%.

The invention relates to a metal foil essentially comprising nickel and tungsten.

Very pure nickel alloys are susceptible to material faults, such as cracks and breaks, during hot forming (e.g. slab-rolling), especially when a cast ingot (e.g. VIM) is re-melted (e.g. VAR).

Very pure alloys are needed for specific applications, such as e.g. superconducting strips, so there are conflicting goals in such cases.

DE 100 05 861 C2 discloses a metal material based on nickel and a method for producing it. The material has a cubic recrystallization texture and comprises a nickel alloy having the composition Niₐ (Mo_{b}, W_{c})_{d} Mₑ, where M stands for one or a plurality of metals with the exception of Ni, Mo, Fe, or W, and

a=100−(d+e)
(d+e)≦50
b=0−12
c=0−12
d=(b+c)=0.01−12
e=0−49.9
each in atom % and with any minor production-related impurities.

For production, initially an alloy of the aforesaid composition is produced using fusion metallurgy or powder metallurgy or using mechanical alloying and this alloy is processed to create a strip using hot-forming and subsequent high-quality cold-forming. The strip is subjected to recrystallizing annealing in a reducing or non-oxidizing atmosphere. Today such alloys are essentially smelted only on the laboratory scale, or in small amounts in the kg range so that the purity can be very high. However, this measure cannot necessarily be converted to industrial application on the scale of tons. On the contrary, it is to be assumed that this material, as a block of several hundred millimeters in diameter, will break during hot forming and the output of said material will therefore drop below the economically viable limit for a commercial product.

DE 10 2004 041 053 B4 describes a thick REBCO layer for coated conductors, the layer being produced using chemical solution deposition (CSD) and a high-temperature superconductor strip conductor including at least one substrate material, one buffer layer, and one high-temperature superconductor. This patent has to do with applying the buffer and superconductor layers to the substrate, but does not go into the special qualities of the substrate itself.

A metal strip for epitactic coatings and a method for producing them is known from DE 102 00 445 B4. The metal strip comprises a composite layer made of at least one biaxially textured base layer of the metals Ni, Cu, Ag, or their alloys and at least one additional metal layer, the individual additional metal layers comprising one or a plurality of intermetal phases or comprising one metal that includes one or a plurality of intermetal phases. The nickel-tungsten system is not mentioned, nor are challenges that arise in industrial production, in particular during hot-forming.

The underlying object of the invention is to optimize a metal foil essentially comprising nickel and tungsten by adding defined alloy elements such that in the framework of industrial-scale applications it is very economical with very little waste and at the same time the demands for further processing to create the high-temperature superconductor composite layer are satisfied.

This object is attained using a metal foil having (in weight %):

### Ni 74-90%

### W 10-26%

and Al and/or Mg and/or B in contents of

### Al >0-0.02%

### Mg >0-0.025%

### B >0-0.005%

and unavoidable accompanying elements in contents of <0.5%.

Preferred contents of Ni and W are (in weight %):

| | | | |
|---|---|---|---|
| Ni | 80-90% | Ni | 83-88% |
| W | 10-20% | W | 12-17% |

For increasing the purity of this alloy, the contents of Ni and W can be limited even further, specifically (in weight %):

### Ni 85-87%

### W 13-15%

For further increasing purity, the inventive metal foil is provided with contents of Al and/or Mg and/or B (in weight %) as follows to improve processing of the alloy:

| | | | |
|---|---|---|---|
| Al | 0.001-0.02% | Al | 0.0001-0.0006% |
| Mg | 0.0001-0.025% | Mg | 0.0001-0.015% |
| B | 0.0001-0.005% | B | 0.0001-0.002% |

The following elements and associated contents (in weight %) are considered accompanying elements (production-related impurities):

### Cr max. 0.05%

### Fe <0.1%

### Co max. 0.05%

### C max. 0.04%

### Cu <0.05%

### Mn <0.05%

### Mo max. 0.05%

### Nb max. 0.01%

### P <0.004%

### O <0.005%

### S <0.004%

### Si max. 0.05%

### N <0.005%

### Ti <0.01%

In order to be able to provide the desired purity for the alloy, in particular with industrial-scale smelting >1 t, especially >3 t, if possible the aforesaid accompanying elements should be below the aforesaid limits.

Currently for industrial-scale applications it appears to be possible to attain the following limits for the accompanying elements that are undesired per se at costs that are economically viable from a commercial standpoint (in weight %):

### Cr. <0.01%

### Fe <0.05%

### Co <0.05%

### C <0.01%

### Cu <0.03%

### Mn <0.03%

### Mo <0.03%

### Nb <0.005%

### P <0.003%

### O <0.004%

### S <0.0008%

### Si <0.04%

### N <0.004%

### Ti <0.01%

The inventive metal foil is preferably used as a metal strip for epitactic coatings as for DE 102 00 445 B4.

The starting material produced using VIM and where needed VAR is hot formed, processed in a special production process using a high degree of cold forming (>90%), and then annealed in the temperature range between 700° C. and 1200° C. A large amount of cubic texture is formed during this. The purity of the alloy must be very high in order to attain a high quality with respect to the portion with cubic texture, that is, the content of the aforesaid accompanying elements that impede the formation of the cubic texture must be very small. It should particularly be stressed that, in contrast to the prior art according to DE 100 05 861 C2, even industrial-scale operations in the weight range >3 t are possible without having to jeopardize the demands on the purity of the inventive alloy.

The conflicting goals mentioned in the foregoing are now reconciled by the specific addition of the elements Mg and/or B and/or Al, since these elements promote good or improved hot formability for the starting material produced on an industrial scale and in the case of the described additives satisfy requirements with respect to the characteristics of the cubed texture without limiting the ability of the metal foil to be further processed.

According to a further thought of the invention, a metal foil is proposed whose surface has a static contact angle <80° that is measured with a mixture of deionized water and propionic acid in a ratio of essentially 1:1.

In certain applications it can make sense to provide a static contact angle <75°, or <70°.

Table 1 provides chemical compositions for three inventive laboratory batches and one batch >3 t (in weight %) produced on an industrial scale in accordance with the invention:

| Batch no. | LB 2000 | LB 2002 | LB 2004 | GT 171325 |
|---|---|---|---|---|
| Element | Weight % | Weight % | Weight % | Weight % |
| Al | <0.001 | <0.001 | 0.006 | 0.005 |
| B | <0.001 | <0.001 | 0.001 | 0.001 |
| Mg | <0.001 | 0.013 | 0.01 | 0.003 |
| Ni | 86.727 | 86.001 | 85.747 | 85.55 |
| W | 13.25 | 13.94 | 14.09 | 14.3 |
| Cr | 0.006 | 0.008 | 0.024 | 0.01 |
| Fe | <0.005 | <0.005 | 0.07 | 0.05 |
| Co | 0.005 | 0.006 | 0.007 | 0.01 |
| C | 0.002 | 0.003 | <0.003 | 0.004 |
| Cu | <0.001 | <0.006 | 0.002 | 0.01 |
| Mn | <0.001 | <0.001 | 0.001 | 0.01 |
| Mo | 0.004 | 0.005 | 0.012 | 0.01 |
| Nb | 0.001 | 0.001 | 0.001 | 0.001 |
| P | <0.002 | <0.002 | 0.002 | 0.002 |
| O | <0.002 | 0.004 | 0.004 | 0.003 |
| S | <0.001 | <0.001 | <0.002 | 0.0005 |
| Si | <0.001 | 0.014 | 0.017 | 0.02 |
| N | <0.001 | <0.001 | <0.004 | 0.002 |
| Ta | 0.005 | 0.005 | 0.005 | |
| Ti | <0.001 | <0.001 | <0.001 | 0.01 |

In contrast to laboratory batches LB 2000, LB 2002, and LB 2004, batch GT 171325 was produced with a melt volume of 5 t. Alloy GT 171325, produced on an industrial-scale, was smelted with the VIM method. A comparison of the laboratory batches and the batch produced on an industrial scale demonstrates that the batch produced on an industrial scale is not inferior to the laboratory-scale batches with respect to its purity and thus economical production with minimized waste of the later products is possible.

It was possible to hot-roll the VIM starting material with no problem from ingot to slab and further to hot-rolled strip. No breaks occurred. The strip was processed using a high degree of cold forming (>90%) in a special production process and then was annealed in the temperature range between 850 and 1150° C. With respect to the high purity of the batch thus produced on an industrial scale, a high quality for the cubed texture portion could be attained due to the controlled addition of Al and/or Mg and/or B in the inventive contents.

The method for measuring the static contact angle is described in greater detail in the following:

This method facilitates characterization of the surface properties of solids. Water or a 1:1 mixture of water and propionic acid is suitable for determining the properties of the Ni—W strip. The water used was purified using an ion exchanger and was to have a residual conductivity of less than 5.0 μScm⁻¹. The propionic acid is 99.5% pure and has a density between 0.993 and 0.995 gcm⁻³. It did not undergo any special treatment.

The measurement is performed on an Axiotech reflected light microscope using an Epiplan 5×/0.13 HD lens. Since it is not possible to measure from above, the beam path of the microscope is deflected 90° using a mirror so that the image is recorded from the side.

The surface of the specimen must be as flat as possible so that, if it must be cut, it is preferably cut with a side-cutter instead of a shears. If possible the strip is stored under dry protective gas (99.99% nitrogen) until just before the measurement in order to prevent surface oxidation from corrupting the measurement results. In addition, the strip is cleaned with i propanol in the ultrasound bath for 15 min and dried in a vacuum at 80° C.

The specimen is fixed on a slide and pressed lightly, avoiding denting. The required liquid is applied using a syringe with a cannula, and the volume applied should always be the same. The measurement is taken at 22° C.

The measurement is evaluated using a suitable graphics program. The contact angle Θ is found from the height h of the drop and the width I using the equation

$$tan ( \frac{Θ}{2} ) = 2 \frac{h}{I}$$

Sufficient wetting with coating solutions is attained when the contact angle of the strip with deionized water is not greater than 80°, and extremely good wetting is attained when the contact angle to water is less than 60°. If the contact angle is large and in particular if it is greater than 90°, it is not possible to apply a texturized layer to the Ni—W substrate after wetting.

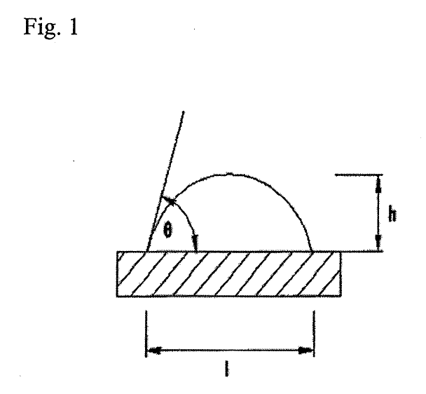

The subject-matter of the invention is depicted in FIGS. 1 through 3. The figures show:

FIG. 1 Determination of the contact angle Θ

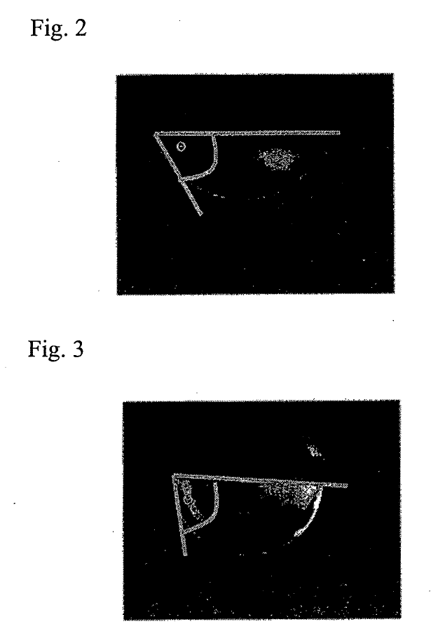

FIG. 2 Contact angle <75°. The substrate is well coated during coating with precursor solution.

FIG. 3 Contact angle >80°. Coating with precursor solution leads to unsatisfactory results.

1. Metal foil comprising, by weight,
Ni 80-90%
W 10-20%
and at least one of Al, Mg or B in respective weight proportions,
Al 0.0001-0.02%
Mg 0.0001-0.015%
B 0.0001-0.005%.

2. (canceled)

3. Metal foil in accordance with claim 1, wherein respective weight proportions of Ni and W are
Ni 83-88%
W 12-17%.

4. Metal foil in accordance with claim 1, wherein respective weight proportions of Ni and W are
Ni 85-87%
W 13-15%.

5. (canceled)

6. Metal foil in accordance with claim 1, comprising at least one of Al or B in respective weight proportions
Al 0.0001-0.006%
B 0.0001-0.002%.

7. Metal foil in accordance with claim 1, wherein any content of the hereinbelow listed elements is limited as follows, by weight:
Cr max. 0.05%
Fe <0.1%
Co max. 0.05%
C max. 0.04%
Cu <0.05%
Mn <0.05%
Mo max. 0.05%
Nb max. 0.01%
P <0.004%
O <0.005%
S <0.004%
Si max. 0.05%
N <0.005%
Ti <0.01%.

8. Metal foil in accordance with claim 1, wherein any content of the hereinbelow listed elements is limited as follows, by weight:
Cr. <0.01%
Fe <0.05%
Co <0.05%
C <0.01%
Cu <0.03%
Mn <0.03%
Mo <0.03%
Nb <0.005%
P <0.003%
O <0.004%
S <0.0008%
Si <0.04%
N <0.004%
Ti <0.01%.

9. Metal foil in accordance with claim 1 produced by a degree of cold forming >90%, followed by annealing at 700° C. to 1200° C.

10. Metal foil in accordance with claim 1, wherein surfaces of the foil have a static contact angle <80° that is measured with a mixture of deionized water and propionic acid in a ratio of 1:1.

11. Metal foil in accordance with claim 1, wherein surfaces of the foil have a static contact angle <75° that is measured with a mixture of deionized water and propionic acid in a ratio of 1:1.

12. Metal foil in accordance with claim 1, wherein surfaces of the foil have a static contact angle <70° that is measured with a mixture of deionized water and propionic acid in a ratio of 1:1.

13. Metal foil in accordance with claim 1 produced in smelting quantities greater than one ton.

14. A metal strip for epitactic coatings comprising a metal foil in accordance with claim 1.
